(19) United States
(12) Patent Application Publication
(10) Pub. No.: US 2010/0096860 A1
(43) Pub. Date: Apr. 22, 2010

(54) GRAVITY-DRIVEN ENGINE

(76) Inventor: Fernando Regis, Naples, FL (US)

Correspondence Address: EDWARD M. LIVINGSTON, PA, 963 TRAIL TERRACE DRIVE, NAPLES, FL, 34103, US

(21) Appl. No.: 12/253,954

(22) Filed: Oct. 18, 2008

(51) Int. Cl. F03G 7/00; F03G 7/10

(52) U.S. Cl. 290/1 R; 415/916

(57) ABSTRACT

A gravity-driven engine (1) having at least one pulley (2) connected to a pulley support frame (33), a spring (24) connected to the pulley support frame (33), an output shaft (20) having a fly wheel (10) located thereon and wherein the at least one pulley (2) is connected to the fly wheel (10), a lever arm (6) rotatable about the output shaft (20) and a weight (5) rotatable about the output shaft (20) and in connection with the lever arm (6). When the weight (5) descends from a zero degree vertical position by gravitational force, the spring (24) compresses as the weight (5) rotates in a circular manner to approximately 345 degrees. When the weight (5) is approximately 345 degrees from the vertical position, the spring (24) decompresses and makes contact with the lever arm (6), thereby pushing the weight (5) the remaining 15 degrees and resulting in an overall rotational torque caused by gravity which thereby causes rotation of the output shaft (24).

### BACKGROUND OF THE INVENTION

This invention relates to engines, more particularly, a gravity-driven engine that provides power to other devices, such as generators, fans, air conditioning units, vehicles and so forth.

As the world's supply of non-renewable resources continues to be depleted at an astonishing rate, the need to find alternative power sources has become a major issue on the local, national and international level. Solar, wind and hydroelectric power are common examples of power generated via renewable resources. Although these power sources are environmentally-friendly, they are inconsistent and, therefore, unreliable.

For example, solar energy is energy from the sun that is converted into thermal or electric energy. Although this type of energy is good in theory, there are many locations in the world wherein sunlight is scarce, thereby not making it a viable option as a power source. Similarly, wind power is also a variable form of energy wherein wind must be available to convert the wind energy into electric energy. Thus, if there is little to no wind, there is little to no energy produced. Finally, hydroelectric power, which is generated by the force associated with moving water, is also variable as droughts or floods cause a decrease or increase, respectively, in the electric power produced. Moreover, it is arguable as to whether or not water is truly a renewable resource as due to the increasing world population, the demand for water is greater than water's ability to replenish itself through the groundwater and surface water.

Therefore, a need exists for an engine that utilizes an environmentally-friendly and renewable power source wherein the power source is constants

The relevant prior art includes the following references:

| Patent/Ser. No. | Inventor | Issue/Publication Date |
|---|---|---|
| (U.S. unless stated otherwise) | | |
| 2008/0001579 | Claypool | Jan. 03, 2008 |
| 2008/0036216 | Lin | Feb. 14, 2008 |
| EP1,767,779 | Roselli | Mar. 28, 2007 |
| WO 2007/116040 | Molfesi | Oct. 18, 2007 |
| WO2007/135473 | Thangadurai | Nov. 29, 2007 |
| GB2,425,410 | Lin | Oct. 25, 2006 |
| CA2,510,255 | Oshiro | Jun. 20, 2005 |
| 2004/0066042 | Pessemier | Apr. 08, 2004 |
| 2003/0011261 | White | Jan. 16, 2003 |
| 6,237,342 | Hurford | May 29, 2001 |
| JP2000228864 | Toshio | Aug. 15, 2000 |
| 5,221,868 | Arman | Jun. 22, 1993 |
| JP6,328,346 | Takasuga | Nov. 21, 1988 |
| BE905623 | Ronny | Feb. 16, 1987 |
| JP60190682 | Kunio | Sep. 28, 1985 |
| JP58069477 | Haruyasu | Apr. 25, 1983 |
| GB314,234 | Stead | Jun. 27, 1929 |
| GB16,749 | Brabbins | Jul. 19, 1910 |

### SUMMARY OF THE INVENTION

The primary object of the present invention is to provide a gravity-driven engine that utilizes an environmentally-friendly power source.

Another object of the present invention is to provide a gravity-driven engine that utilizes a renewable power source.

An even further object of the present invention is to provide a gravity-driven engine that utilizes a constant power source.

Another object of the present invention is to provide a gravity-driven engine that may be used to operate various types of electrically-operated equipment.

The present invention fulfills the above and other objects by providing a gravity-driven engine having a pulley housing, at least one pulley connected to the pulley housing and to at least one pulley support frame, a spring connected to the at least one pulley support frame wherein the spring is in a decompressed first position, the spring having at least one impact point, a base housing connected to the pulley housing, an output shaft having at least one fly wheel located thereon wherein the output shaft is located within the base housing, the at least one pulley is connected to the fly wheel located on the output shaft, a lever arm rotatable about the output shaft, at least one weight rotatable about the at least one output shaft and in connection with the at least one lever arm wherein when the at least one weight is less than approximately 345 degrees from a zero degree vertical position, the at least one spring compresses from the first position into a compressed second position and decompresses when the at least one weight is equal to or greater than approximately 345 degrees from a zero degree vertical position, the lever arm having at least one impact point wherein the spring impact point makes contact with the lever arm impact point when the spring extends into the decompressed first position, thereby resulting in an overall rotational torque caused by gravity which thereby causes rotation of the output shaft.

An optional gear box may be connected to the output shaft, as well as an optional wind generator magnetic motor mechanism. A charger control battery may be connected to the wind generator magnetic motor mechanism, a battery may be connected to the charger control battery and an electric converter may be connected to the battery.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of a gravity-driven engine of the present invention wherein the pulleys are in a vertical orientation;

FIG. 2 is a rear view of a gravity-driven engine of the embodiment of FIG. 1;

FIG. 3 is a front view of a gravity-driven engine of the embodiment of FIG. 1;

FIG. 4 is a perspective view of a weight and lever arm of the present invention;

FIG. 5 is an enlarged front view of the pulleys of the gravity-driven engine of the present invention wherein all of the pulleys are in a vertical orientation;

FIG. 6 is an enlarged side view of the pulleys of the gravity-driven engine of the present invention wherein some of the pulleys are moveable;

FIG. 7 is a side view of a gravity-driven engine of the present invention wherein the pulleys are in a horizontal orientation; and

FIG. 8 is a side view of the horizontal pulleys of FIG. 7.

### DESCRIPTION OF THE PREFERRED EMBODIMENTS

For purposes of describing the preferred embodiment, the terminology used in reference to the numbered components in the drawings is as follows:

| | |
|---|---|
| 1. | base housing |
| 2. | pulley, generally |
| 3. | cable |
| 4. | bracket |
| 5. | weight |
| 6. | lever arm |
| 7. | gear box |
| 8. | wind generator magnetic motor |
| 9. | battery |
| 10. | fly wheel |
| 11. | bearing |
| 12. | drop-down panel |
| 13. | handle |
| 14. | spring impact point |
| 15. | off switch |
| 16. | input/output |
| 17. | electric converter |
| 18. | battery control charger |
| 19. | electric switch |
| 20. | output shaft |
| 21. | bearing support |
| 22. | pulley housing |
| 23. | nut |
| 24. | spring |
| 25. | gravity-driven engine, generally |
| 26. | stability bar |
| 27. | lever arm impact point |
| 28. | first position |
| 29. | second position |
| 30. | pulley wheel |
| 31. | leg |
| 32. | bottom side |
| 33. | pulley support frame |
| 34. | axle |
| 35. | sliding bar |
| 36. | sleeve |

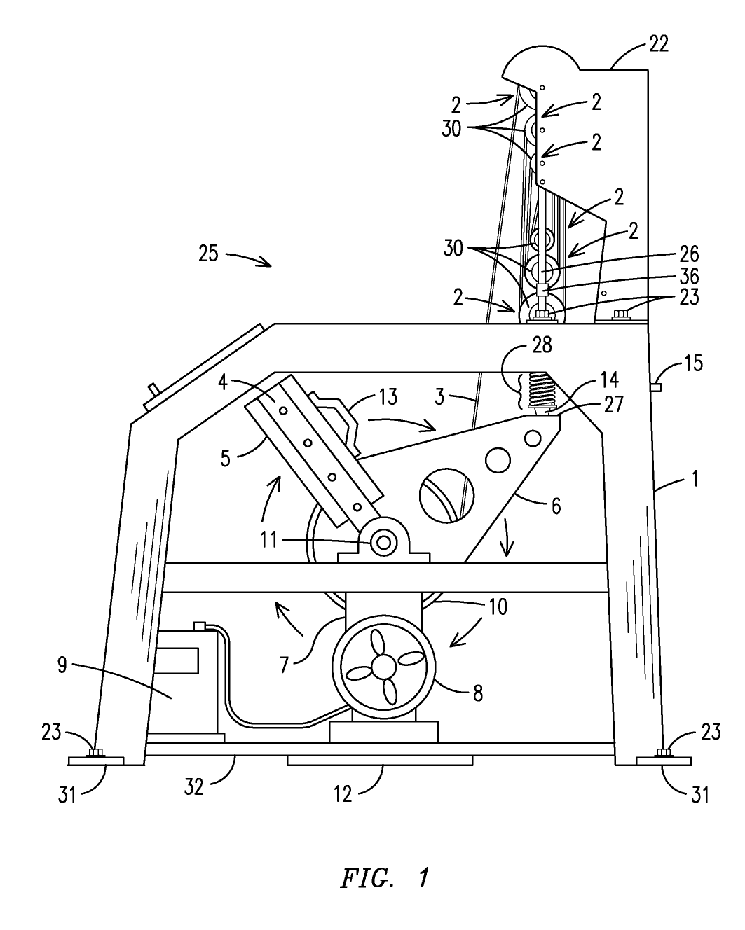

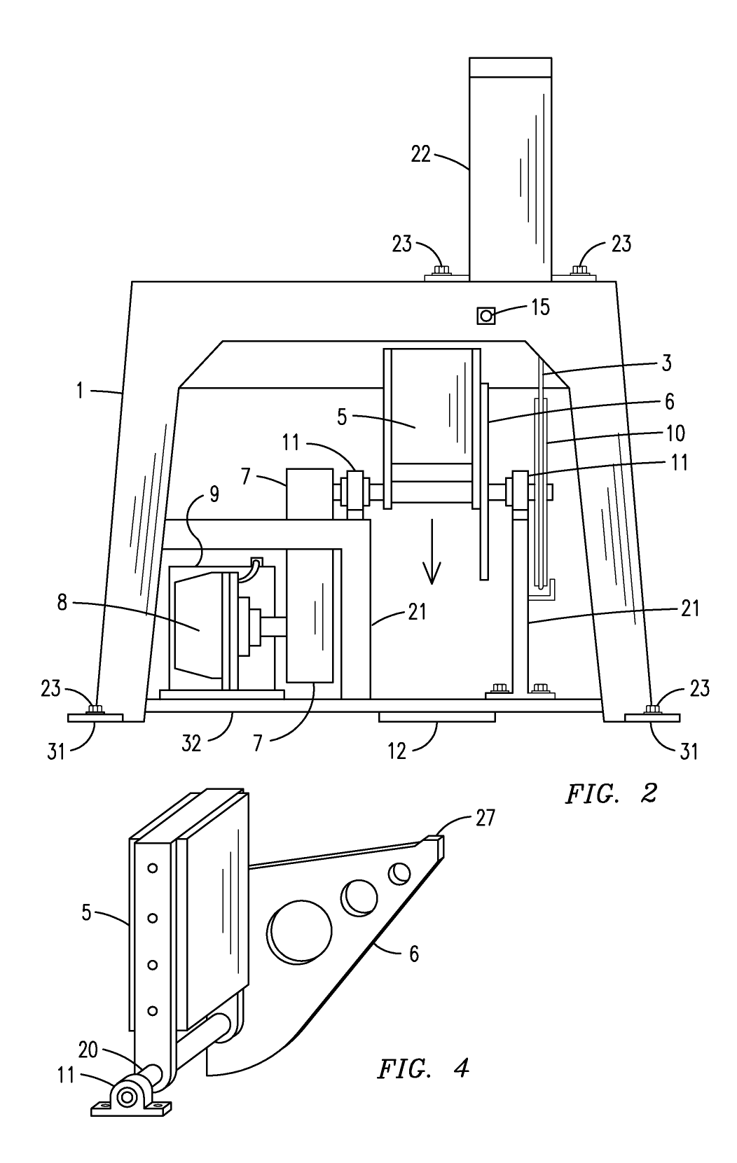

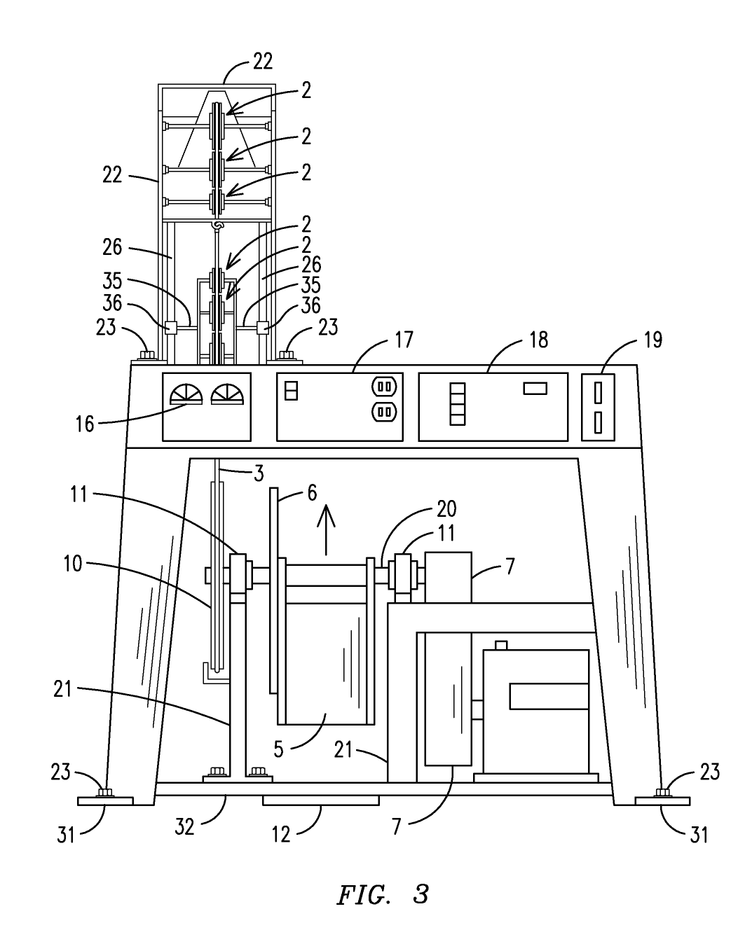

With reference to FIGS. 1, 2 and 3, varying views of a gravity-driven engine wherein the pulleys are in a vertical orientation of the present invention are shown. The gravity-driven engine, generally 25, includes a base housing 1 and a pulley housing 22 attached thereto via a fastening means, which may be at least one nut 23, wherein the operational components of the gravity-driven engine 25 are preferably located therein. The base housing 1 preferably includes at least one leg 31 which is preferably anchored to a firm surface, such as a floor or planar surface of an object. A drop-down panel 12 may be located on a bottom side 32 of the base housing 1 to permit a user to easily access the operational components of the gravity-driven engine 25.

The gravity-driven engine 25 includes at least one pulley, generally 2, which is preferably located within the pulley housing 22, wherein the at least one pulley 2 is connected to at least one fly wheel 10, which is preferably located within the base housing 1. The pulleys 2 are standard-type pulleys 2 wherein a pulley wheel 30 having a channel or notch therein accepts a cable 3, cord, rope, belt or the like. Although the cable 3 of the pulley 2 extends to the fly wheel 10, the function of the fly wheel 10 differs from that of the pulleys 2 as the fly wheel 10 pulls the cable 3 in a downward manner and releases it during operation, as described below.

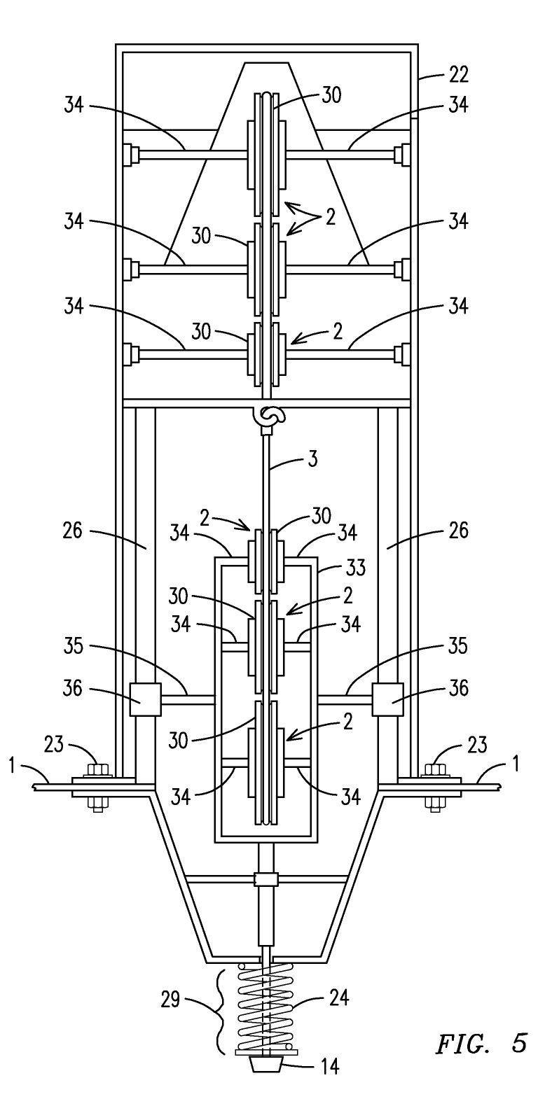

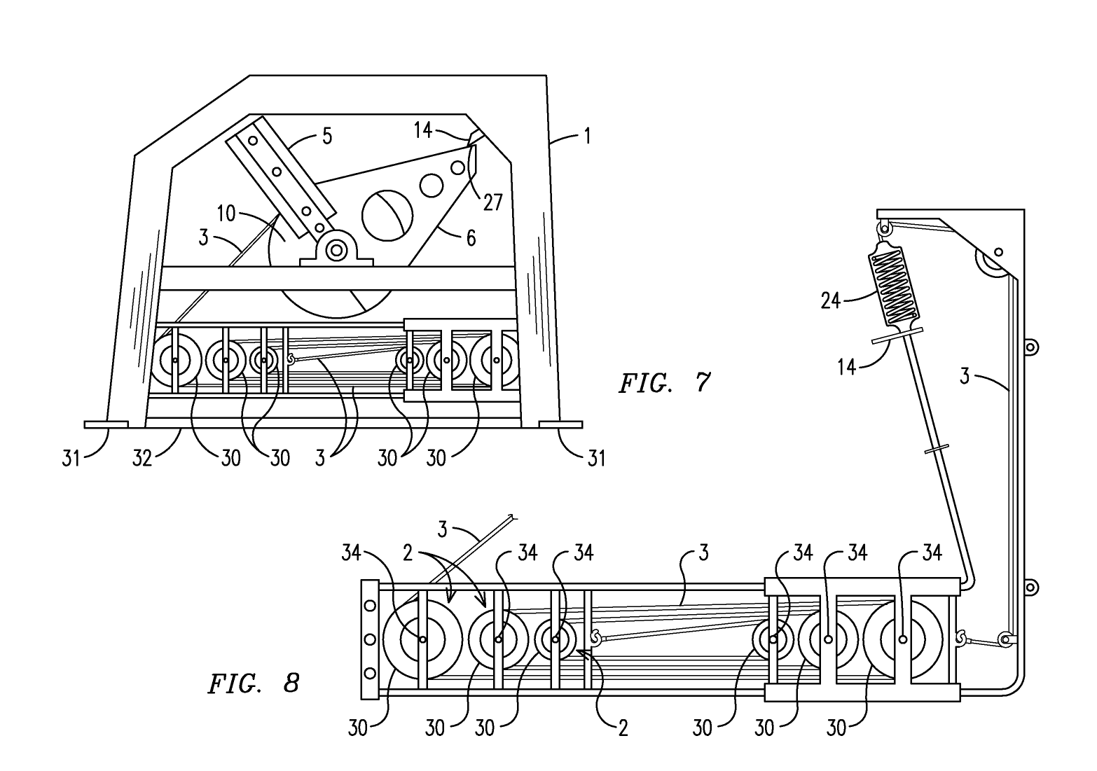

The gravity-driven engine 25 preferably utilizes a total of six pulleys 2 wherein the upper three pulleys 2 are preferably stationary, that is, fixed to the pulley housing 22, and the lower three pulleys 2 are preferably moveablely attached to the pulley housing 22 or at least one stability bar 26 via at least one sliding bar 35 and at least one sleeve 36 so that the bottom three pulleys may move up and down, as shown in FIG. 5. Moreover, although a total of six pulleys 6 in a vertical configuration are shown, varying amounts of pulleys 2 is differing configurations, such as horizontal, may also be utilized as shown in FIGS. 7 and 8 and as described below.

At least one spring 24 is connected to at least one pulley support frame 33 wherein a distal end of the spring has a spring impact point 14, which is preferably a rubber stopper. The spring 24 remains in a decompressed first position 28 and, when the spring is charged according to the manner described below, compresses to a compressed second position 29.

At least one output shaft 20 is preferably located within the base housing 1 and is mounted in bearings 11, which are preferably frictionless, near each end of the output shaft 20. The bearings 11 are preferably located on bearing supports 21. The output shaft 20 is connected on one end to the fly wheel 10 and is connected on the other end to at least one gear box 7. At least one lever arm 6 and at least one weight 5 are rotatable about the output shaft 20. The weight 5, which is preferably lead but may be any material, is in connection with the at least one lever arm 6 and may include a handle 13. The lever arm 6 includes at least one lever arm impact point 27, which is preferably located on the distal end of the lever arm 6.

The fly wheel 10 is configured such that the cable 3 of the pulley 2 is pulled and automatically released at approximately 345 degrees of rotation of the weight 5 as the pulley 2 rotates.

A bracket 4 may be located on the shaft 20 for holding a predetermined number of weights 5. However, inclusion of such bracket 4 is not required for the operation of the present invention.

The gear box 7 is preferably a reduction-type gear box 7 that increases the revolutions per minute (RPM's) of the descending weight 5 in proportion to the amount of weight 5 utilized.

A wind generator magnetic motor mechanism 8 is preferably connected to the gear box 7. The wind generator magnetic motor mechanism 8 is connected to a battery control charger 18. The battery control charger 18, in turn, is connected to a battery 9. Finally, the battery 9 is connected to an electric converter 17.

An off switch 15, electric switch 19 and input/output 16 are preferably located on the front of the base housing 1 to permit a user to operate the device.

FIG. 4 shows a perspective view of the weight and lever arm utilized in the gravity-driven engine of the present invention. The weight 5 and lever arm 6 are rotatable about the output shaft 20, which is mounted in at least one bearing 11, which is preferably frictionless. The weight 5, which is preferably lead but may be any material, is in connection with the lever arm 6. The lever arm 6 includes at least one lever arm impact point 27, which is preferably located on the distal end of the lever arm 6.

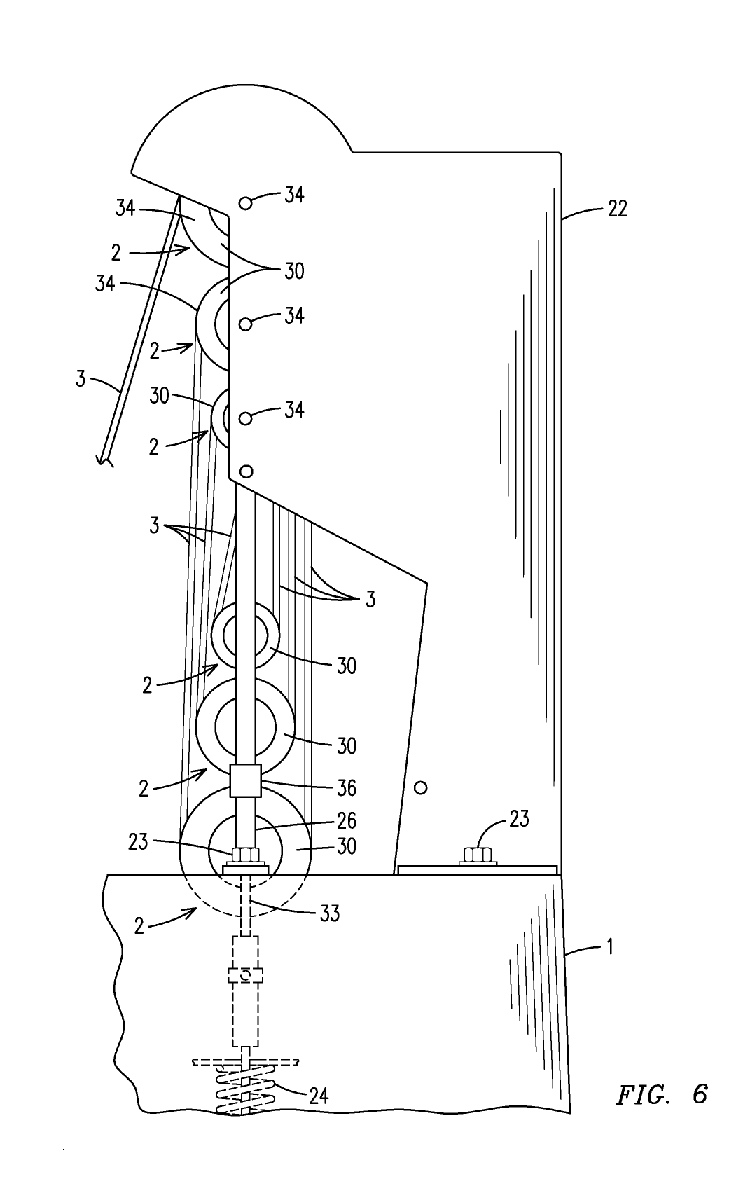

With respect to FIG. 5, an enlarged front view of the pulleys of the gravity-driven engine of the present invention wherein all of the pulleys are fixed is shown. The pulley wheels 30 of the pulleys 2 are mounted on axles 34. Some of the pulleys 2, in this case, the upper three as shown in FIGS. 5 and 6, may be mounted directly to the pulley housing 22, thereby causing these pulleys 2 to be fixed, or non-moving. On the other hand, some of the pulleys 2, in this case, the lower three as shown in FIG. 6, may have each axle 34 secured to a pulley support frame 33 which, in turn, are moveablely attached to the pulley housing 22 or at least one stability bar 26 via at least one sliding bar 35 and at least one sleeve 36 so that the bottom three pulleys may move up and down.

FIG. 6 shows a side view of the pulleys of the gravity-driven engine of the present invention wherein some of the pulleys are moveable. Similar to the upper three pulleys 2 shown in FIG. 6, the upper three pulleys 2 are fixed to the pulley housing 22 while the lower three pulleys 2 are secured to a pulley support frame 33. However, the lower three pulleys 2 as shown in FIG. 5 are not fixed to the pulley housing 22 and, therefore, are movable.

FIGS. 7 and 8 shows a side view of a gravity-driven engine of the present invention wherein the pulleys are in a horizontal orientation and the horizontal pulleys, respectively. Rather than having the pulleys 2 oriented vertically as shown in FIGS. 1-3, 5 and 6, the pulleys 2 are oriented in a horizontal position. Although the orientation of the pulleys 2 in FIGS. 7 and 8 differ from those shown in FIGS. 1-3, 5 and 6, the operation and overall structure of the gravity-driven engine 25 remains the same.

Although the preferred embodiment of the invention includes the use of six total pulleys 2, the present invention may be utilized with at least one pulley 2, gears, levers, hydraulic presses, springs, etc.

To use the present invention, momentum is first created by moving the weight 5 a predetermined amount from a zero degree vertical start position so as to allow gravity to pull the weight 5 downward and rotationally about the output shaft 20, all the while gaining kinetic energy. The kinetic energy remains unchanged until the weight 5 is located approximately at 345 degrees from the vertical start position, at which time the weight 5 would normally ultimately return to 180 degrees from the vertical start position However, in order to overcome the 15 degree difference, the pulleys 2 are utilized.

The pulleys 2 charge the spring 24 when the weight 5 is located less than approximately 345 degrees from the vertical start position such that the spring 24 compresses from the decompressed first position 28 to the compressed second position 29. The use of the pulleys 2 reduces the required power from its original starting power. When the weight 5 is located at approximately 345 degrees from the vertical start position, the cable 3 around the fly wheel 10 is released, thereby permitting the spring 24 to decompress into the first position 28. When decompressed, the spring impact point 14 makes contact with the lever arm impact point 27, thereby rotating the lever arm 6 about the output shaft 20. The rotation of the lever arm 6, which is connected to the weight 5, causes rotation of the weight 5, thereby permitting the weight 5 to overcome the remaining 15 degrees of the rotational cycle and pass a 360 revolution about the output shaft 20. At this point, because the weight 5 has momentum, it does not need to be moved in order to make additional rotational cycles.

The rotation of the output shaft 20 has a predetermined revolutions per minute (RPM). Because a gear box 7 is connected to the output shaft 20, the RPM's arc increased. The gear box 7 is ultimately connected to an electric converter 17, which permits a user to connect an electrically-operated device, such as a generator, fan, air conditioning unit, etc., to the gravity-driven engine 25 for operation.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A gravity-driven engine comprising:
at least one pulley having at least one cable and at least one wheel;
at least one pulley support frame connected to said at least one pulley;
said at least one pulley support frame is in connection with at least one spring in a decompressed first position;
said at least one spring having at least one impact point;
at least one output shaft having at least one fly wheel located thereon;
said at least one pulley is connected to said at least one fly wheel located on said at least one output shaft;
at least one lever arm rotatable about said at least one output shaft;
at least one weight rotatable about said at least one output shaft and in connection with said at least one lever arm wherein when said at least one weight is less than approximately 345 degrees from a zero degree vertical position, said at least one spring compresses from said first position into a compressed second position and decompresses when said at least one weight is equal to or greater than approximately 345 degrees from a zero degree vertical position; and
said at least one lever arm having at least one impact point, wherein said at least one spring impact point makes contact with said at least one lever arm impact point when said at least one spring extends into said decompressed first position which results in an overall rotational torque caused by gravity which thereby causes rotation of said output shaft.

2. The gravity-driven engine of claim 1 further comprising:
at least one gear box connected to said at least one output shaft.

3. The gravity-driven engine of claim 1 further comprising:
at least one wind generator magnetic motor mechanism connected to said at least one output shaft.

4. The gravity-driven engine of claim 2 further comprising:
at least one wind generator magnetic motor mechanism connected to said at least one output shaft.

5. The gravity-driven engine of claim 4 further comprising:
at least one charger control battery connected to said at least one wind generator magnetic motor mechanism.

6. The gravity-driven engine of claim 5 further comprising:
at least one battery connected to said at least one charger control battery.

7. The gravity-driven engine of claim 6 further comprising:
at least one electric converter connected to said at least one battery.

8. The gravity-driven engine of claim 1 further comprising:
at least one handle located on said at least one weight.

9. The gravity-driven engine of claim 1 further comprising:
at least one base housing wherein said at least one output shaft is located therein.

10. The gravity-driven engine of claim 2 further comprising:
at least one base housing wherein said at least one output shaft is located therein.

11. The gravity-driven engine of claim 1 further comprising:
at least one pulley housing wherein said at least one pulley is connected thereto.

12. The gravity-driven engine of claim 2 further comprising:
at least one pulley housing wherein said at least one pulley is connected thereto.

13. The gravity-driven engine of claim 9 further comprising:
at least one pulley housing connected to said at least one base housing wherein said at least one pulley is connected to said at least one pulley housing.

14. The gravity-driven engine of claim 10 further comprising:
at least one pulley housing connected to said at least one base housing wherein said at least one pulley is connected to said at least one pulley housing.

15. The gravity-driven engine of claim 1 wherein:
said at least one output shaft is mounted in at least one bearing.

16. The gravity-driven engine of claim 2 wherein:
said at least one output shaft is mounted in at least one bearing.

17. A gravity-driven engine comprising:
at least one pulley housing;
at least one pulley having at least one cable and at least one wheel wherein said at least one pulley is connected to said at least one pulley housing;
at least one pulley support frame connected to said at least one pulley;
said at least one pulley support frame is in connection with at least one spring in a decompressed first position;
said at least one spring having at least one impact point;
at least one base housing connected to said at least one pulley housing;
at least one output shaft having at least one fly wheel located thereon;
said at least one output shaft is located within said at least one base housing;
said at least one pulley is connected to said at least one fly wheel located on said at least one output shaft;
at least one lever arm rotatable about said at least one output shaft;
at least one weight rotatable about said at least one output shaft and in connection with said at least one lever arm wherein when said at least one weight is less than approximately 345 degrees from a zero degree vertical position, said at least one spring compresses from said first position into a compressed second position and decompresses when said at least one weight is equal to or greater than approximately 345 degrees from a zero degree vertical position;
said at least one lever arm having at least one impact point, wherein said at least one spring impact point makes contact with said at least one lever arm impact point when said at least one spring extends into said decompressed first position which results in an overall rotational torque caused by gravity which thereby causes rotation of said output shaft;
at least one gear box connected to said at least one output shaft;
at least one wind generator magnetic motor mechanism connected to said at least one output shaft;
at least one charger control battery connected to said at least one wind generator magnetic motor mechanism;
at least one battery connected to said at least one charger control battery; and
at least one electric converter connected to said at least one battery.

18. A gravity-driven engine comprising:
at least one pulley housing;
at least one pulley having at least one cable and at least one wheel wherein said at least one pulley is connected to said at least one pulley housing;
at least one pulley support frame connected to said at least one pulley;
said at least one pulley support frame is in connection with at least one spring in a decompressed first position;
said at least one spring having at least one impact point;
at least one base housing connected to said at least one pulley housing;
at least one output shaft is mounted in at least one bearing;
at least one fly wheel located on said at least one output shaft;
said at least one output shaft is located within said at least one base housing;
said at least one pulley is connected to said at least one fly wheel located on said at least one output shaft;
at least one lever arm rotatable about said at least one output shaft;
at least one weight rotatable about said at least one output shaft and in connection with said at least one lever arm wherein when said at least one weight is less than approximately 345 degrees from a zero degree vertical position, said at least one spring compresses from said first position into a compressed second position and decompresses when said at least one weight is equal to or greater than approximately 345 degrees from a zero degree vertical position;
said at least one lever arm having at least one impact point, wherein said at least one spring impact point makes contact with said at least one lever arm impact point when said at least one spring extends into said decompressed first position which results in an overall rotational torque caused by gravity which thereby causes rotation of said output shaft;
at least one gear box connected to said at least one output shaft;
at least one wind generator magnetic motor mechanism connected to said at least one output shaft;
at least one charger control battery connected to said at least one wind generator magnetic motor mechanism;
at least one battery connected to said at least one charger control battery; and
at least one electric converter connected to said at least one battery.
